(19) United States
(12) Patent Application Publication
(10) Pub. No.: US 2010/0095589 A1
(43) Pub. Date: Apr. 22, 2010

(54) REFORMER HAVING A CATALYTIC DEVICE AND A HEAT EXCHANGER AND METHOD FOR OPERATING A REFORMER

(76) Inventor: Johannes Eichstaedt, Neubrandenburg (DE)

Correspondence Address: FITCH, EVEN, TABIN & FLANNERY, P. O. BOX 18415, WASHINGTON, DC, 20036, US

(21) Appl. No.: 12/595,409

(22) PCT Filed: Apr. 14, 2008
(86) PCT No.: PCT/DE08/00625

§ 371 Date: Oct. 9, 2009

(30) Foreign Application Priority Data
Apr. 16, 2007 (DE) 10 2007 017 787.0

(51) Int. Cl. C01B 3/36; B01J 7/00; H01M 8/06

(52) U.S. Cl. 48/61; 48/197 R

(57) ABSTRACT

The invention relates to a reformer (10) for converting fuel (32) and oxidant (34) into a reformate (30), comprising a catalytic device (12) through which the fuel (32) and oxidant (34) can flow via a catalyst inlet (36), and a heat exchanger (14). According to the invention, the heat exchanger (14) is in heat-exchanging communication with least one segment of the catalytic device (12) adjacent to the catalyst inlet (36). The invention further relates to a method for operating such a reformer (10).

The invention relates to a reformer for converting fuel and oxidising agent into reformate comprising catalyst means through which the fuel and the oxidising agent can flow via a catalyst inlet, and a heat exchanger.

The invention further relates to a method for operating such a reformer.

Increasingly the use of fuel cells for the generation of electric energy gains importance in the field of motor vehicles. For example the further development of auxiliary power units (APUs) is aspired to introduce energy into the on-board network of the vehicle with the aid of said units and to enable a supply of power to electric consumers disposed in the vehicle independent of the operation of the internal combustion engine in that way.

For generating this electric energy often SOFC fuel cells (solid oxide fuel cells) are used which are supplied with reformate discharged from a reformer to enable the generation of electric energy. Among others the catalytic partial oxidation is known as a type of reforming of the reformer in which the reformate is produced from the oxidising agent and the fuel using a catalyst. In this connection fuel, for example natural gas, gasoline or diesel fuel, is mixed with, for example, air as the oxidising agent and oxidised inside of a catalyst or inside of a catalyst means. Usually primarily strongly exothermal reactions take place at a catalyst inlet of the catalyst which lead to a strong increase in temperature in the area of the catalyst inlet. In the area of a catalyst outlet of the catalyst means which is positioned downstream of the catalyst inlet with respect to the flow direction of the oxidising agent or the fuel primarily endothermal reforming reactions take place which lead to a decrease in the catalyst temperature as compared to the temperatures at the catalyst inlet. In this way a commonly known, typical temperature distribution is obtained in the catalyst of the reformer. One possibility to prevent an excessively high temperature in the catalyst or the exceeding of a threshold temperature in the catalyst is the control of the air number or the lambda value (the air/fuel ratio) of the reformer, namely by adjusting the oxidising agent supply rate or the air supply rate in the reformer. Such a control is, for example, effected by adjusting the rotational speed of an air fan for supplying air into the reformer. Since the reformer converts an oxygen of the oxidising agent directly in the area or in the vicinity of the catalyst inlet it reacts to changes of the lambda value with strong temperature gradients or temperature variations. Said strong temperature variations which occur at least in the area of the catalyst inlet severely aggravate the control of the air number of the reformer. In addition the oxidising agent supply often cannot be adjusted accurately enough to enable a complete exclusion of an excessive heating of the catalyst means.

From the DE 103 55 494 A1 a system and a method for converting fuel and oxidising agent into a reformate is already known. In this document according to the state of the art a reformer is described which comprises a heat exchanger for removing reaction heat generated during the reforming process from the reformer. Said heat exchanger is, in this case, allocated to a certain portion of the reformer, however, not to a specific component of the reformer. The removal of heat from the reformer alone, however, is not sufficient to improve the controllability of the air number of the reformer, particularly when the controllability of the air number, among others, strongly depends on an operating temperature of a specific component of the reformer. In addition the heat removal which is independent of the reformer component is not sufficient to ensure that the temperatures of sensitive components are within a temperature range for which these components are designed.

Particularly in connection with reformers comprising a catalyst means an overheating of the catalyst means may occur particularly easily if the control of the air number of the reformer is carried out by adjusting the rotational speed of the fan to effect a change of the lambda value. The change of the lambda value is, in this connection, relatively large despite of the modest change of the rotational speed and is therefore also accompanied by a high increase of the temperature. A heat removal which is independent of the reformer component can, however, not compensate such a strong increase of the temperature. Therefore there is still the risk of an overheating of sensitive components.

The invention is therefore based on the object to further develop the generic reformer and method for operating reformers so that the control of the air number of the reformer can be ensured while simultaneously reducing the risk of an overheating of components of the reformer.

The reformer according to the invention is based on the generic state of the art in that a heat-transferring relationship exists between the heat exchanger and at least a portion of the catalyst means adjacent to the catalyst inlet. Therefore there is the possibility that the portion of the catalyst means can be heated via the heat exchanger as well as cooled during the reforming operation. The controllability of the air number of the reformer is improved by the fact that by adjusting the heat transmission to the heat exchanger correspondingly increases in temperature in the area of the catalyst inlet can be compensated. Therefore the risk of overheating during the control of the air number of the reformer is reduced and therefore the controllability of the reformer is enormously improved.

The reformer according to the invention can advantageously be further developed so that the portion extends from the catalyst inlet in the direction of a catalyst outlet passed after the catalyst inlet in a predetermined degree. The portion may, in this case, for example extend, to a predetermined degree, from one end of the catalyst which is formed by the catalyst inlet in the direction of the catalyst outlet which is formed by the other end of the catalyst. Accordingly the catalyst inlet represents an upstream end and the catalyst outlet a downstream end of the catalyst means. Preferably said portion has a length of approximately ⅓ of the length of the catalyst means or ½ of the length of the catalyst means.

Above that the reformer according to the invention may be realised so that a mixture formation chamber to which the oxidising agent and the fuel are supplyable and via which a mixture of the oxidising agent and the fuel is supplyable to the catalyst means is provided upstream of the catalyst means. Preferably furthermore a heat transmitting relationship exists between the heat exchanger and at least a portion of the mixture formation chamber. In this way a heating or, in certain cases, also a cooling of the mixture may already be effected in the mixture formation chamber.

The reformer according to the invention may further be embodied so that a chamber through which the oxidising agent can flow, which is connected to the heat exchanger via a coupling and via which the oxidising agent is at least partly supplyable to the heat exchanger is provided upstream of the mixture formation chamber. In this way the controllability of the reformer may be further improved; in particular it is then preferred that the heat exchanger is passed by the same flowing medium as the oxidising agent. In connection with the reformer according to the invention preferably heat exchanger air is used as the heat exchanger fluid and reformer air as the oxidising agent. Owing to the coupling between the chamber and the heat exchanger the reformer air can flow into the heat exchanger depending on a pressure difference between the chamber and the heat exchanger. This means that the reformer air may, depending on the pressure difference, escape via the heat exchanger, for example via bores forming the coupling to the heat exchanger. In this case the pressure prevailing in the heat exchanger is lower than the pressure in the mixture formation chamber. In this way a lower lambda value or a lower air number is established in the reformer than the one that would usually have developed had an escape of the oxidising agent not been possible; even if the introduced substance amounts of combustion gas as the fuel and reformer air as the oxidising agent are increased to maintain the calculated lambda value the air number in the reformer may in addition be controlled by adjusting des amount of the escaping oxidising agent. The control of the air number of the reformer is, in this case, additionally carried out via the heat exchanger air supply and the pressure difference between the heat exchanger and the reformer.

Furthermore the reformer may advantageously be realised so that at least a pressure difference between a pressure prevailing in the mixture formation chamber and a pressure prevailing in the heat exchanger and/or a temperature at the catalyst inlet are detectible by at least one sensor. Thus the control of the air number of the reformer may, for example, be carried out on the basis of the detection of the pressure difference or the temperature using the sensor.

The reformer according to the invention may further be realised so that control/regulation means allocated to the reformer are provided which are capable of controlling/regulating an air number of the reformer on the basis of at least the detected pressure difference and/or the detected temperature. In the case of the control of the reformer using the pressure difference between the heat exchanger and the reformer the control parameters are extended, the air number of the reformer no longer reacting so abruptly upon changes of the rotational speed of a reformer fan since the lambda in the reformer is subject to smaller changes due to the division of the reformer air volume flow.

Above that the reformer according to the invention may be formed so that the control-/regulation means are capable of controlling/regulating the air number of the reformer by adjusting at least a heat exchanger fluid supply to the heat exchanger and/or an oxidising agent supply to the mixture formation chamber. In this way the heat transfer to the heat exchanger as well as from the heat exchanger may be regulated or controlled. In connection therewith the pressure difference is also adjusted so that the portion of the reformer air escaping into the heat exchanger can be determined.

The method according to the invention is based on the generic state of the art in that a temperature at a portion of the catalyst means adjacent to at least the catalyst inlet between which and the heat exchanger a heat transmitting relationship exists is controlled or regulated by adjusting a heat transfer from or to the heat exchanger. In this way the advantages explained in connection with the reformer according to the invention are obtained in a similar or the same manner which is the reason why reference is made to the explanations given in connection with the reformer according to the invention to avoid repetitions.

The same applies analogously for the following preferred embodiments of the method according to the invention, reference being made to the explanations given in connection with the reformer according to the invention in this connection as well to avoid repetitions.

The method according to the invention may advantageously be further developed so that the temperature is controlled or regulated at the portion which extends from the catalyst inlet in the direction of a catalyst outlet passed after the catalyst inlet in a predetermined degree.

The method according to the invention may further be realised so that the catalyst means is supplied with the oxidising agent and the fuel via a mixture formation chamber in which a mixture of the oxidising agent and the fuel is generated.

The method according to the invention may further be realised so that the oxidising agent is supplied to a chamber connected to the mixture formation chamber before reaching the mixture formation chamber, said chamber being connected to the heat exchanger via a coupling so that the oxidising agent is at least partially supplyable to the heat exchanger.

Above that the method according to the invention may be realised so that at least a pressure difference between a pressure prevailing in the mixture formation chamber and a pressure prevailing in the heat exchanger and/or a temperature at catalyst inlet is detected.

Furthermore the method according to the invention may be configured so that an air number of the reformer is controlled or regulated on the basis of at least the detected pressure difference and/or the detected temperature.

The method according to the invention may, above that, be further developed so that the air number of the reformer is controlled or regulated by adjusting at least a heat exchanger fluid supply to the heat exchanger and/or an oxidising agent supply to the mixture formation chamber.

A preferred embodiment of the invention will be explained below by way of example with reference to the Figure in which:

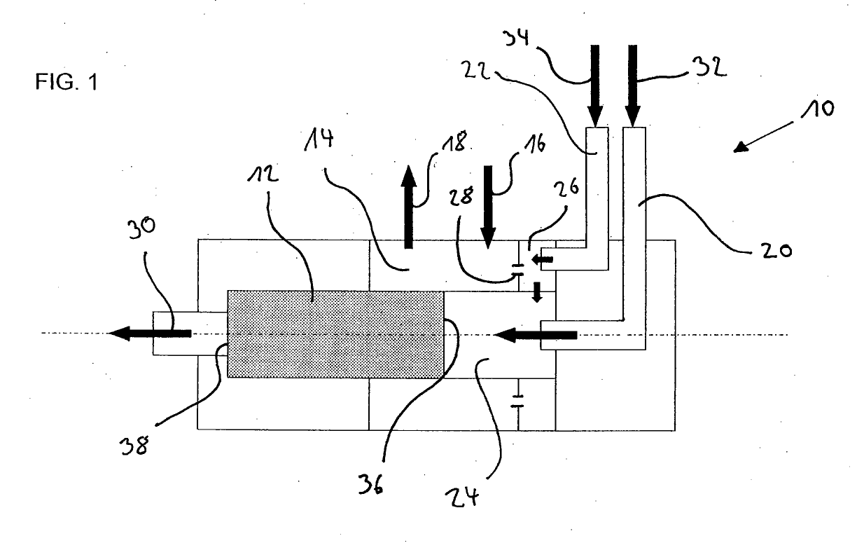

FIG. 1 is a strongly schematised representation of the reformer according to the invention which is capable of carrying out the method according to the invention.

FIG. 1 shows a strongly schematised representation of the reformer 10 according to the invention which is capable of carrying out the method according to the invention. In the present embodiment the reformer 10 is a component of a fuel cell system comprising an SOFC fuel cell or a SOFC fuel cell stack. The reformer 10 according to the invention serves to generate a reformate 30 of an oxidising agent 34 and a fuel 32 supplied to the reformer 10 generated by reforming by means of a catalytic partial oxidation. The reformate 30 generated in this way is again supplied to the fuel cell stack which is thus operable for generating electric energy.

The reformer 10 comprises a fuel supply means 20 via which the fuel 32, i.e., for example, natural gas, gasoline or diesel fuel, is supplyable to the a mixture formation chamber 24 of the reformer 10. The reformer 10 further comprises an oxidising agent supply means 22 via which the oxidising agent 34, in this embodiment air, is supplyable to the mixture formation chamber 24. The reformer 10 further comprises catalyst means 12 coupled to the mixture formation chamber 24 via the catalyst inlet of which a mixture of the fuel 32 and the oxidising agent 34 formed in the mixture formation chamber 24 can enter the catalyst means 12. Above that the catalyst means 12 comprises a catalyst outlet 38 via which the reformate 30 is supplyable to the fuel cell or fuel cell stack (not shown). In this embodiment the catalyst inlet 36 and the catalyst outlet 38 respectively represent one end of the catalyst means 12, the catalyst inlet 36 forming the upstream end and the catalyst outlet 38 the downstream end of the catalyst means 12 with respect to the flow direction of the oxidising agent 34 or the fuel 32.

In this embodiment the oxidising agent 34 is supplyable to the mixture formation chamber 24 via the oxidising agent supply means 22, however, the oxidising agent 34 supplied by the oxidising agent supply means 22 flows through a chamber 26 before reaching the mixture formation chamber 24. Said chamber 26 can be formed as desired, for example in the form of a conduit or in another way, and extends, at least in sections, adjacent to a heat exchanger 24 of the reformer 10. The chamber 26 is coupled to the heat exchanger 14 via a coupling 28, for example in the form of one or more bores. A heat transmitting relationship exists between a portion of the heat exchanger 14 and the catalyst means 12. Further a heat transmitting relationship exists between another portion of the heat exchanger 14 and the mixture formation chamber 24. A heat exchanger fluid, in this embodiment air, is supplyable to the heat exchanger 14 via supply means 16, and the heat exchanger fluid is dischargeable via a discharge means 18 so that the degree of a heat exchange is adjustable via the supply and discharge of the heat exchanger fluid. In this embodiment therefore the heat exchanger fluid as well as the oxidising agent 34 is air.

The method according to the invention for operating the reformer 10 according to the invention is as follows. First the mixture formation chamber 24 is supplied with the oxidising agent 34 and the fuel 32 via the oxidising agent supply means 22 and the fuel supply means 20. In the mixture formation chamber 24 a mixture of the oxidising agent 34 and the fuel 32 is generated in the manner known to those skilled in the art; for example by applying an angular momentum which may be generated by corresponding oxidising agent supplies to the oxidising agent before it reaches the mixture formation chamber. The mixture is introduced into the catalyst means 12 via the catalyst inlet 36 and flows through the catalyst means 12 to the catalyst outlet 38. Here the mixture is converted into the reformate 30 in the reforming process by means of the catalytic partial oxidation. Due to the exothermal reactions occurring in this way, particularly in the area of the catalyst inlet 36, the temperature of the catalyst means 12 rises primarily in the area or in the vicinity of the catalyst inlet 36. In contrast a temperature which is low as compared to the temperature in the area of the catalyst inlet 36 is given in the area of the catalyst outlet 38 due to predominantly endothermal reforming reactions. To prevent an overheating of the catalyst means 12, primarily in the area of the catalyst inlet 36, among others the oxidising agent supply or the air amount supply in the mixture formation chamber 24 is controlled so that the air number in the reformer 10 is changed correspondingly. In this way an overheating of the catalyst means 36 in the catalyst inlet area can generally be prevented. However, to likewise prevent strong temperature variations of the catalyst means 12 and variations of the air number in the reformer 10 further a heat exchanger fluid supply/discharge is adjusted. On the one hand this results in a heat removal from the catalyst means 12 to the heat exchanger 14 which removes the heat by means of the heat exchanger fluid. On the other hand a pressure difference between a pressure prevailing in the heat exchanger 14 and a pressure prevailing in the mixture formation chamber 24 is adjusted in this way. Said pressure difference depends, among others, on the adjustment of the oxidising agent supply and the heat exchanger fluid supply/discharge. To prevent, for example, an excessive change of the air number in the reformer 10 and an accompanying temperature variation of the catalyst means 12 the heat exchanger is first supplied with heat exchanger fluid to such an extent that the pressure in the heat exchanger is lower than the pressure in the mixture formation chamber 24. Therefore the oxidising agent 34 flows into the heat exchanger 14 via the coupling 28 of the chamber 26 before reaching the mixture formation chamber 24 whereby first the amount of the increase of the air number can be reduced. In this way further an unsuitably high air number variation in the reformer and an accompanying unsuitably high increase of the temperature of the catalyst means 12 are prevented. In this way the pressure difference and with it the volume flow of the oxidising agent 34 flowing into the heat exchanger can be adjusted and finely metered via the heat exchanger fluid supply/discharge. The pressure difference can thus be adjusted by respectively adjusting the oxidising agent supply and the heat exchanger fluid supply/discharge so that first an unsuitably high variation of the air number is prevented. At the same time heat is removed by the heat exchanger 14 at least in the area of the catalyst inlet 36 via the heat exchanger 14. In this way further the overheating of the catalyst means 12 is prevented. Preferably the pressure difference between the pressure prevailing in the heat exchanger 14 and the pressure prevailing in the mixture formation chamber 24 can be detected by means of a pressure difference sensor, the detection of the respective oxidising agent and heat exchanger fluid supply also being possible. In addition or alternatively it is also feasible to detect a temperature in the area of the catalyst inlet 36 by means of a temperature sensor. From the temperature in connection with the characteristics the corresponding oxidising agent and heat exchanger fluid supply as well as the prevailing air number may also be determined.

Conversely the heat exchanger 12 may, of course, also be operated for heating the catalyst means 12, for example when the reformer 10 is to be operated in a burner mode.

The features of the invention disclosed in the above description, in the drawings as well as in the claims may be important for the realisation of the invention individually as well as in any combination.

### LIST OF NUMERALS

10 reformer
12 catalyst means
14 heat exchanger
16 supply means
18 discharge means
20 fuel supply means
22 oxidising agent supply means
24 mixture formation chamber
26 chamber
28 coupling
30 reformate
32 fuel
34 oxidising agent
36 catalyst inlet
38 catalyst outlet

1. A reformer for converting fuel and oxidising agent into reformate, said reformer comprising catalyst means through which the fuel and the oxidising agent can flow via a catalyst inlet, and a heat exchanger, characterised in that a heat transmitting relationship exists between the heat exchanger and at least a portion of the catalyst means disposed adjacent to the catalyst inlet.

2. The reformer of claim 1, characterised in that the portion extends from the catalyst inlet in the direction of a catalyst outlet passed after the catalyst inlet in a predetermined degree.

3. The reformer of claim 1, characterised in that a mixture formation chamber to which the oxidising agent and the fuel are supplyable and via which a mixture of the oxidising agent and the fuel is supplyable to the catalyst means is provided upstream of the catalyst means.

4. The reformer of claim 3, characterised in that a chamber through which the oxidising agent can flow and which is connected to the heat exchanger via a coupling is provided upstream of the mixture formation chamber, the oxidising agent being at least partly supplyable to the heat exchanger via said chamber.

5. The reformer of claim 4, characterised in that at least a pressure difference between a pressure prevailing in the mixture formation chamber and a pressure prevailing in the heat exchanger and/or a temperature at the catalyst inlet is detectable by at least one sensor.

6. The reformer of claim 5, characterised in that control/regulation means allocated to the reformer are provided which are capable of controlling/regulating an air number of the reformer on the basis of at least the detected pressure difference and/or the detected temperature.

7. The reformer of claim 6, characterised in that the control/regulation means is capable of controlling/regulating the air number of the reformer by adjusting at least a heat exchanger fluid supply to the heat exchanger and/or an oxidising agent supply to the mixture formation chamber.

8. A method for operating a reformer for converting a fuel and an oxidising agent into a reformate, said reformer comprising a catalyst means through which the fuel and the oxidising agent can flow via a catalyst inlet, and a heat exchanger, characterised in that a temperature at a portion of the catalyst means between which and the heat exchanger a heat transmitting relationship exists and which is disposed adjacent to at least the catalyst inlet is controlled or regulated by adjusting a heat transfer to or from the heat exchanger.

9. The method of claim 8, characterised in that the temperature is controlled or regulated at the portion extending from the catalyst inlet in the direction of a catalyst outlet passed after the catalyst inlet in a predetermined degree.

10. The method of claim 8, characterised in that the catalyst means is supplied with the oxidising agent and the fuel via a mixture formation chamber in which a mixture of the oxidising agent and the fuel is generated.

11. The method of claim, characterised in that the oxidising agent is supplied to a chamber connected to the mixture formation chamber before reaching the mixture formation chamber, said chamber being connected to the heat exchanger via a coupling so that the oxidising agent is at least partly supplyable to the heat exchanger.

12. The method of claim 11, characterised in that at least a pressure difference between a pressure prevailing in the mixture formation chamber and a pressure prevailing in the heat exchanger and/or a temperature at the catalyst inlet is detected.

13. The method of claim, characterised in that an air number of the reformer is controlled or regulated on the basis of at least the detected pressure difference and/or the detected temperature.

14. The method of claim 13, characterised in that the air number of the reformer is controlled or regulated by adjusting at least a heat exchanger fluid supply to the heat exchanger and/or an oxidising agent supply to the mixture formation chamber.
